(19) United States
(12) Patent Application Publication
(10) Pub. No.: US 2012/0140440 A1
(43) Pub. Date: Jun. 7, 2012

(54) INDUCTIVELY POWERED LIGHTING ASSEMBLY

(75) Inventors: Robert Dam, Aurora, IL (US); Michael W. Hartley, Elmhurst, IL (US); Karl S. Morgan, Des Plaines, IL (US); Richard R. Herzog, Arlington Heights, IL (US); Chong B. Wong, Vernon Hills, IL (US); John G. Drelicharz, Palatine, IL (US)

(73) Assignee: ILLINOIS TOOL WORKS INC., Glenview, IL (US)

(21) Appl. No.: 13/390,247

(22) PCT Filed: Aug. 6, 2010
(86) PCT No.: PCT/US2010/044667

§ 371 Date: Feb. 13, 2012

Related U.S. Application Data
(60) Provisional application No. 61/233,925, filed on Aug. 14, 2009.

(51) Int. Cl. F21V 33/00

(52) U.S. Cl. 362/92

(57) ABSTRACT

An inductive lighting assembly for an appliance is provided. The appliance includes a cabinet, a liner installed in the cabinet, and at least one shelf mounted in the cabinet. The inductive lighting assembly includes a coil locator channel recessed into the cabinet, a primary coil mounted proximate to the coil locator channel, a shelf having a projection coupled thereto; the projection configured to be at least partially inserted into the coil locator channel to separate a metallic object placed on the shelf from the primary coil by a predetermined distance, and a secondary coil mounted in the projection, the primary coil transferring power to the secondary coil through inductive power transfer, the secondary coil being electrically connected to a light assembly installed in the appliance. A refrigerator including an inductive lighting system is also provided herein.

### CROSS REFERENCE TO RELATED APPLICATION

This Non-Provisional application claims benefit to U.S. Provisional Application Ser. No. 61/233,925 filed on Aug. 14, 2009, the complete subject matter of which is expressly incorporated herein in its entirety.

### BACKGROUND OF THE INVENTION

The present invention relates generally to an inductive power system, and more particularly to an inductively powered lighting assembly for an appliance.

At least one conventional refrigerator includes lights that are mounted to the shelves installed in the refrigerator. The lights receive electric power through inductive power transfer. The conventional refrigerator light system includes a primary coil that is mounted within the structure of the refrigerator and secondary coils mounted to the shelves. Typically the primary coil is mounted flush to the inside wall of the refrigerator hidden from the consumer's sight. The primary coil may also be mounted inside auxiliary shrouds that cover water lines, air ducts, etc. The conventional primary coil is an elongated, oval-shaped winding mounted internal to the refrigerator compartment with its axis in a vertical orientation. As such, the length of the primary coil winding spans many shelf positions and powers multiple secondary coils each mounted on a unique shelf. For the conventional inductive power system to work effectively and efficiently, the secondary coils must be properly positioned with respect to the primary coil. Specifically, the vertical axis of the primary and secondary coils must be aligned and the gap between the primary and secondary coils must be minimized.

During operation, the secondary coils electromagnetically couple with the primary coil. An electrical current induced into the secondary coils is transmitted to the lights to power the lights. However, undesirable situations can occur when metal objects that are placed on the shelves come too close to the primary coil. For example, an aluminum container inadvertently placed in contact with the wall of the refrigerator, next to the primary coil, will divert power from the primary coil that may cause the lighting system to dim, flicker or turn off. Generally, any metallic object that diverts power from the primary coil, due to its close proximity to the primary coil, is called a parasitic metal.

### BRIEF DESCRIPTION OF THE INVENTION

In one embodiment, an inductive lighting assembly for an appliance is provided. The appliance includes a cabinet, a liner installed in the cabinet, and at least one shelf mounted in the cabinet. The inductive lighting assembly includes a coil locator channel recessed into the cabinet, a primary coil mounted proximate to the coil locator channel, a shelf having a projection coupled thereto; the projection configured to be at least partially inserted into the coil locator channel to separate a metallic object placed on the shelf from the primary coil by a predetermined distance, and a secondary coil mounted in the projection, the primary coil transferring power to the secondary coil through inductive power transfer, the secondary coil being electrically connected to a light assembly installed in the appliance. A refrigerator including an inductive lighting system is also provided herein.

In another embodiment, an appliance is provided. The appliance includes a liner having a plurality of recesses formed therein, a primary coil installed proximate to at least one of the recesses, and at least one shelf configured to be inserted into the recess, the shelf including a secondary coil, the primary coil transferring power to the secondary coil through inductive power transfer, the secondary coil being electrically connected to a light assembly installed on the shelf.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a front view of an exemplary appliance in accordance with various embodiments.

FIG. 2 is a front view of a portion of the appliance shown in FIG. 1 in accordance with various embodiments.

FIG. 3 is a front perspective view of a portion of an exemplary inductive lighting assembly that may be utilized with the appliance shown in FIGS. 1 and 2 in accordance with various embodiments.

FIG. 4 is a top view of the exemplary inductive lighting assembly shown in FIG. 3 in accordance with various embodiments.

FIG. 5 is a top view of a portion of another exemplary inductive lighting assembly that may be utilized with the appliance shown in FIGS. 1 and 2 in accordance with various embodiments.

FIG. 6 is a top view of a portion of another exemplary inductive lighting assembly that may be utilized with the appliance shown in FIGS. 1 and 2 in accordance with various embodiments.

FIG. 7 is a top view of a portion of another exemplary inductive lighting assembly that may be utilized with the appliance shown in FIGS. 1 and 2 in accordance with various embodiments.

FIG. 8 is a top view of a portion of another exemplary inductive lighting assembly that may be utilized with the appliance shown in FIGS. 1 and 2 in accordance with various embodiments.

FIG. 9 is a side view of a portion of another exemplary inductive lighting assembly that may be utilized with the appliance shown in FIGS. 1 and 2 in accordance with various embodiments.

FIG. 10 is a front view of a portion of another exemplary inductive lighting assembly that may be utilized with the appliance shown in FIGS. 1 and 2 in accordance with various embodiments.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

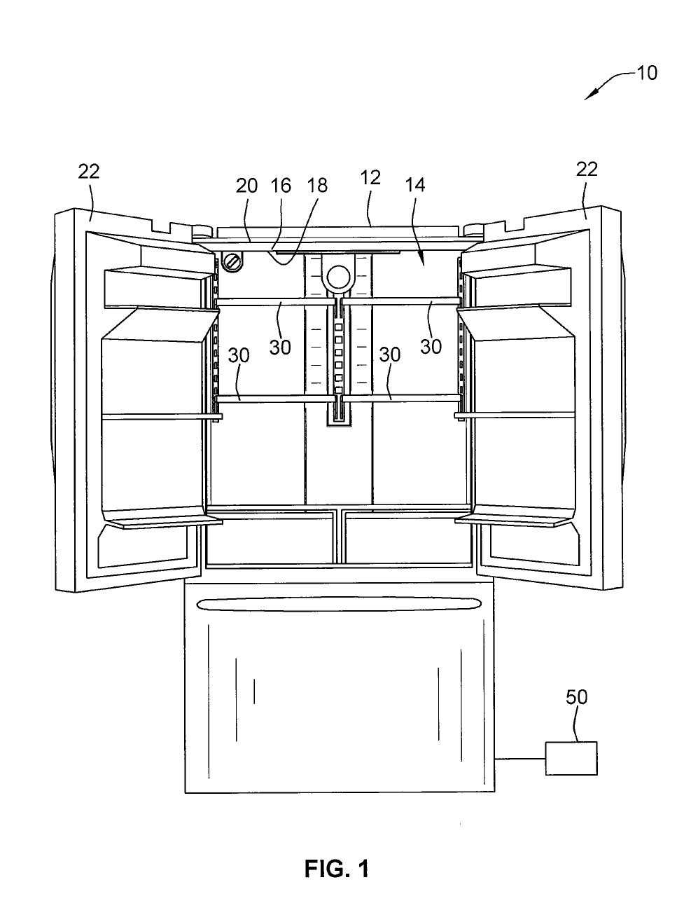

FIG. 1 is a front view of an exemplary appliance 10 that may be configured to include an inductive lighting assembly that is discussed in more detail below. In the exemplary embodiment, the appliance 10 is a refrigerator/freezer appliance fabricated in a “French-door” style. More specifically, the appliance 10 includes a pair of doors that are each configured to be hinged to a respective side of the appliance. During operation, the pair of doors are opened and closed to enable an operator to access items stored within the appliance. It should be realized that although the exemplary embodiment illustrates and describes a French-door style refrigerator/freezer, that the inductive lighting assembly described herein may be installed in any style appliance. For example, the inductive lighting assembly may be installed in a side-by-side refrigerator/freezer. The inductive lighting assembly may also be installed in any appliance or application having repositionable shelves and requiring lighting. For example, the inductive lighting assembly may be installed in a closet having repositionable shelves. The inductive lighting assembly may also be installed in a garage having repositionable shelves.

Referring again to FIG. 1, the appliance 10 includes a cabinet 12 that defines an interior space 14. The interior space 14 is defined by a liner 16 that is installed within the cabinet 12. The liner 16 may separate the interior space 14 of the appliance cabinet 12 from an insulation material (not shown) that is installed between the cabinet 12 and the liner 16. The liner 16 has an interior side 18 and an exterior side 20. The interior side 18 forms the interior wall of the cabinet 12 and the exterior side 20 faces the insulation material (not shown) that is installed between the cabinet 12 and the liner 16.

The appliance 10 also includes a pair of doors 22 that are coupled to the cabinet 12. As discussed above, in the exemplary embodiment, the pair of doors 22 are configured to be hinged to a respective side of the cabinet 12 such that during operation, the pair of doors 22 are opened and closed to enable an operator to access items stored within the interior space 14. The appliance 10 also includes at least one shelf 30. In the exemplary embodiment, the appliance 10 includes a plurality of shelves 30.

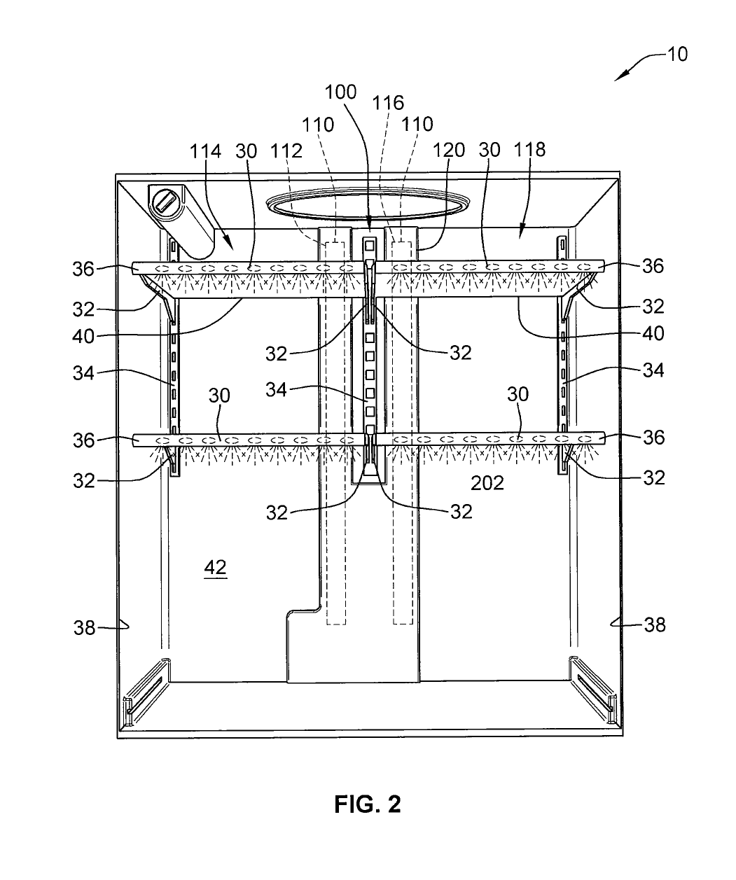

FIG. 2 is a front view of a portion of the appliance 10 shown in FIG. 1. As shown in FIG. 2, each shelf 30 includes two shelf supports 32 that are configured to engage a pair of frame supports 34. In one embodiment, a shelf support 32 may be installed on each side 36 of the shelf 30, and the frame supports 34 may be installed on the sides 38 of the cabinet 12. In the exemplary embodiment shown in FIG. 2, the shelf supports 32 are installed toward a rearward facing edge 40 of the shelf 30 and the frame supports 34 are installed on a rearward side 42 of the cabinet 12.

The appliance also includes an inductive lighting assembly 100. The inductive lighting assembly 100 includes at least one primary coil 110. In the exemplary embodiment, the inductive lighting assembly includes a pair of primary coils 110 wherein each primary coil 110 is configured to supply power to a lighting assembly (shown below) that is installed on each respective shelf 30. For example, the inductive lighting assembly 100 may include a primary coil 112 that supplies power to a column of shelves 114 that are installed on the left interior side of the appliance 10. The inductive lighting assembly 100 may also include a second primary coil 116 that supplies power to a column of shelves 118 that are installed on the right interior side of the appliance 10. In the exemplary embodiment, the primary coils 110 are installed on the rearward side 42 of the cabinet 12 and covered by a plastic shroud 120. The plastic shroud 120 provides a physical barrier to prevent an operator from contacting the primary coils 110 and also improves the overall appearance of the appliance 10. The appliance 10 is connected to and receives power from, an external power supply 50.

Each primary coil 110 may be generally flat, narrow and elongated and are oriented in a vertical orientation. The primary coils 110 are each electrically connected to the power supply circuit 50 as depicted in FIG. 1. The power supply circuit 50 may be connected directly to an external power supply or also a power supply internal to the cabinet 12. It should be realized that although the exemplary embodiment illustrates the inductive lighting assembly 100 as including two primary coils 110, the inductive lighting assembly 100 may include a single primary coil 110 for appliances having only a single column of shelves. Moreover, the inductive lighting assembly 100 may include more than two primary coils 110 for larger appliances or other applications as discussed above.

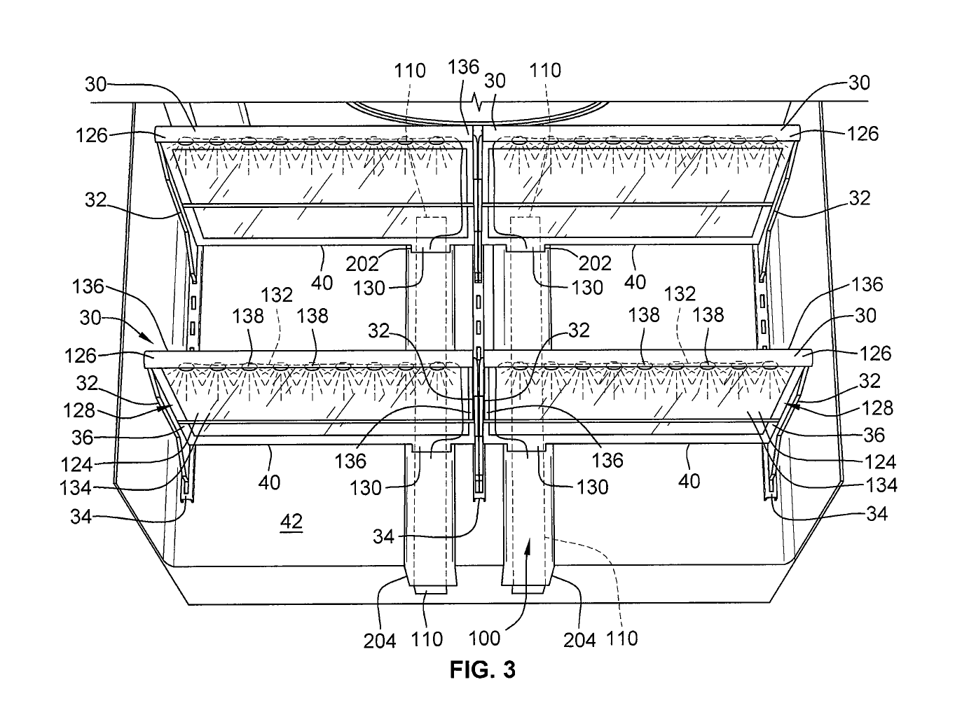

FIG. 3 is a front perspective view of a portion of the exemplary inductive lighting assembly 100 shown in FIG. 2. In the exemplary embodiment, the inductive lighting assembly 100 includes the shelf 30. The shelf 30 includes a piece of glass 124 that is encapsulated within a plastic injection molded border 126. The shelf 30 is mounted onto a metal frame 128. The frame 128 interlocks, via the shelf supports 32, into the pair of frame supports 34, also referred to herein as a ladder. The combination of the shelf supports 32 and the frame supports 34 forms a series of cantilever shelves that may be moved up or down by the consumer to optimize the consumer's space inside the appliance 10.

As shown in FIG. 3, the inductive lighting assembly 100 also includes a secondary coil 130 and a light assembly 132 that are each coupled to the shelf 30. In the exemplary embodiment, the light assembly 132 is coupled to the underside 134 of the shelf 30 proximate to a front edge 136 of the shelf 30. Moreover, the secondary coil 130 is also coupled to the shelf 30 proximate to the rearward edge 40 of the shelf 30. The secondary coil 130 may be coupled in various configurations to the shelf 30. In the exemplary embodiment, the secondary coil 130 is housed within a projection that extends from the shelf 30. Exemplary embodiments of various projections and channels that may be utilized with appliance 10 are discussed in more detail below. Accordingly, when the shelf 30 is mounted within the cabinet 12, by coupling the shelf supports 32 to the frame supports 34, the secondary coil 130 is mounted in close proximity to the primary coil 110. The secondary coil 130 and primary coil 110 are in close proximity in order to help facilitate the inductive power transfer as described below.

In the exemplary embodiment, the light assembly 132 may include features that allow the light assembly 132 to be affixed to the structure of the shelf 30. Generally, the light assembly 132 is attached to the underside 134 of the shelf 30 proximate to the shelf front edge 136. Optionally, the light assembly 132 may also be mounted to the underside 134 of the shelf 30 along the sides 36 of the shelf 30. The light assembly 132 may be embodied as a fluorescent light. In the exemplary embodiment, the light assembly 132 is embodied as plurality of light emitting diodes (LEDs) 138.

In operation, the light assembly 132 receives power through inductive coupling or inductive power transfer from the primary coil 110. As a result of inductive power transfer, power may be wirelessly transferred from the primary coil 110 to the light assembly 132 via the secondary coil 130. The transfer of power takes place by electromagnetic coupling through a process known as mutual induction. The primary coil 110 is positioned proximate to the secondary coil 130 in order to successfully transfer power inductively. Specifically, the power is inductively transferred from the primary coil 110 to the secondary coil 130. The secondary coil 130 then transfers power to the light assembly 132 which in turn then powers and illuminates the LEDs 138 in order to illuminate the interior of the appliance 10.

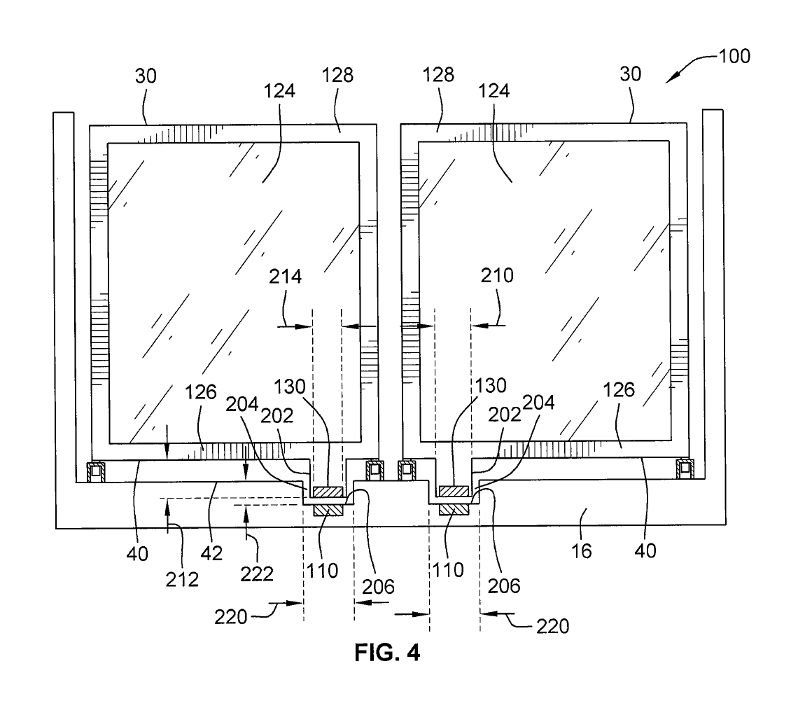

As discussed above, during operation, the secondary coils 130 electromagnetically couple with the primary coil 110. An electrical current induced into the secondary coils 130 is used to power the light assembly 132 mounted on the shelves 30. However, undesirable situations may occur when metal objects that are placed on the shelves 30 come too close to the primary coil 110. Accordingly, FIGS. 4-10 illustrate various exemplary configurations for locating the primary coil 110 and the secondary coil 130 to facilitate preventing parasitic interference that may occur when a metallic container, for example, an aluminum container, is inadvertently placed in contact with the wall or in close proximity to the primary coil 110.

FIG. 4 is a top view of a portion of the exemplary inductive lighting assembly 100 shown FIG. 3 that may be installed on the appliance shown in FIG. 1. The inductive lighting assembly 100 includes at least one shelf 30 that may be installed in the appliance 10 shown in FIGS. 1 and 2. In the exemplary embodiment, the inductive lighting assembly 100 includes a plurality of shelves 30. As shown in FIG. 4, the inductive lighting assembly 100 includes a projection 202 that extends outwardly from the rearward edge 40 of the shelf 30. In the exemplary embodiment, the projection 202 is formed from a plastic material that facilitates shielding the secondary coil 130 housed therein. The projection 202 may be formed separately from, and then attached to, the shelf border 126. Optionally, the projection 202 may be formed unitarily with the shelf border 126. The secondary coil 130 is disposed within the projection 202 such that the secondary coil 130 is substantially parallel to the rearward edge 40 of the shelf 30 and also substantially parallel with the primary coil 110.

The inductive lighting assembly 100 also includes a coil locator channel 204 that is configured to receive at least a portion of the projection 202, and thus the secondary coil 130, therein. In one embodiment, the coil locator channel 204 is formed into the rearward side 42 of the liner 16. More specifically, the liner 16 is molded to form the coil locator channel 204 therein. In the exemplary embodiment, the primary coil 110 is installed proximate to the coil locator channel 204 behind the liner 16. Specifically, the primary coil 110 is installed between a distal end 206 of the channel 204 and the liner 16 such that the primary coil 110 is substantially parallel with the rearward side 42 of the liner 16 and also substantially parallel to the secondary coil 130.

As shown in FIG. 4, the projection 202 has a width 210 and a length 212. The width 210 is selected based on a width 214 of the secondary coil 130 housed therein. Moreover, the length 212 is selected based on a predetermined parasitic resistance desired to be incorporated into the shelf 30. For example, increasing the projection length 212 increases a distance between the shelf 30 and the primary coil 110 and thus increases a distance between metallic objects that may be stored on the shelf 30 and the primary coil 110. The increased distance thus reduces the probability that the metallic objects placed on the shelf will divert power from the primary coil 110 causing the light assembly 132 to dim, flicker, or turn off. Whereas, decreasing the projection length 212 positions the metallic objects closer to the primary coil 110. In the exemplary embodiment, the projection length 212 is sized such that any metallic objects placed on the shelf 30 are sufficiently displaced from the primary coil 110 such that the metallic objects have no effect on the transfer of power from the primary coil 110 to the secondary coil 130.

As shown in FIG. 4, the coil locator channel 204 also has a width 220 and a depth 222. The width 220 is selected based on the width 210 of the projection 202. In the exemplary embodiment, the width 220 is slightly greater than the width 210 of the projection 202 to enable the projection 202 to be inserted therein. Moreover, the width 220 is sized to limit movement between the projection 202 and the coil locator channel 204 and function to guide the operator when installing the shelf 30 into the appliance 10. The width 210 of the projection 202 and the width 220 of the coil locator channel 204 are sized such that when the projection 202 is installed in the coil locator channel 204, the primary coil 110 and the secondary coil 130 are within approximately 5 millimeters along a vertical axis extending through each coil.

The depth 222 is selected based on a predetermined parasitic resistance desired to be incorporated into the shelf 30 as discussed above. It should be realized that the depth 222 of the coil locator channel 204 and the length 212 of the projection 202 are each selected to facilitate ensuring that any metallic objects placed on the shelf 30 are sufficiently displaced from the primary coil 110 such that the metallic objects have no effect on the transfer of power from the primary coil 110 to the secondary coil 130. Moreover, the depth 222 of the coil locator channel 204 and the length 212 of the projection 202 are each selected such that the primary coil 110 is in close proximity to the secondary coil 130 to promote inductive power transfer. The depth 222 of the coil locator channel 204 and the length 212 of the projection 202 are each selected such that the primary coil 110 is separated from the secondary coil 130 by a distance of between approximately 0 millimeters (mm) and approximately 12 mm. In the exemplary embodiment, the depth 222 of the coil locator channel 204 and the length 212 of the projection 202 are each selected such that the primary coil 110 is separated from the secondary coil 130 by a distance of approximately 5 mm. However, it should be realized that the distance separating the primary coil 110 and the secondary coil 130 may be either increased or decreased depending upon the coils utilized and the required inductive power to be transferred to the light assembly 132.

As shown in FIG. 4, the projection 202 may be formed as an integral part of the shelf 30. Optionally, the secondary coil 130 may be housed in a discreet enclosure (not shown) that is mounted to the shelf frame 128. The projection 202 and channel 204 may be located anywhere along the back edge 40 of the shelf 30 and the cabinet. For example, the projection 202 and the channel 204 may be located in the exact center of the width of the shelf 30 such that the shelves 30 are interchangeable from the right column to the left column as shown in FIG. 2.

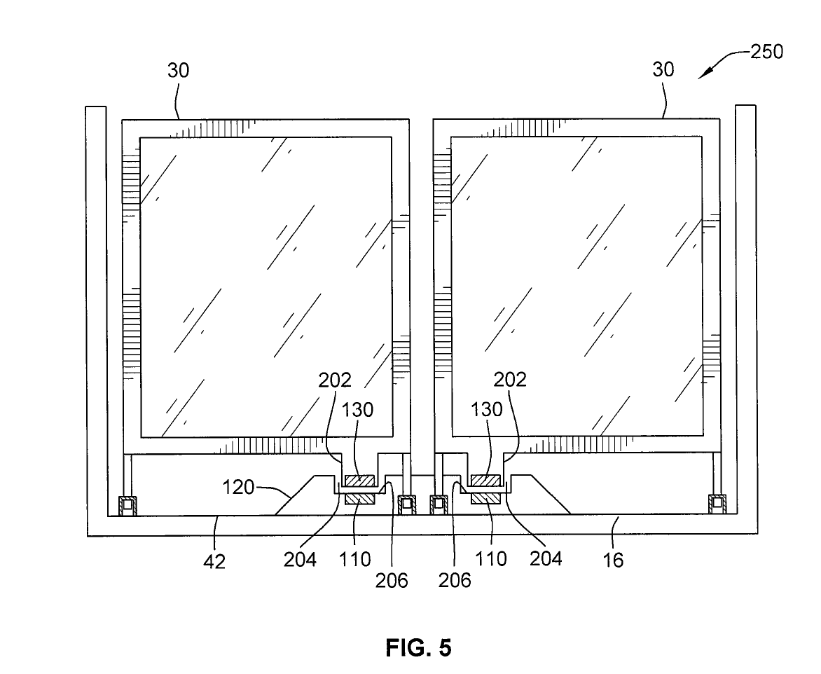

FIG. 5 is a top view of a portion of another exemplary inductive lighting assembly 250 that may be installed on the appliance 10 shown in FIG. 1. The inductive lighting assembly 250 is substantially similar to the inductive lighting assembly 100 described above. The inductive lighting assembly 250 includes a plurality of shelves 30 wherein each shelf 30 includes the projection 202 described above. In this embodiment, the inductive lighting assembly 250 includes the shroud 120. As shown in FIG. 5, in this exemplary embodiment, the shroud 120 is molded to form the coil locator channel 204 therein. The shroud 120 may be formed as a large injection molded component that is utilized to cover the primary coil 110 and also cover water lines, air ducts, etc. In the exemplary embodiment, the primary coil 110 is installed proximate to the coil locator channel 204 behind the shroud 120. Specifically, the primary coil 110 is installed between the distal end 206 of the coil locator channel 204 and the shroud 120 such that the primary coil 110 is substantially parallel with the rearward side 42 of the liner 16 and also substantially parallel to the secondary coil 130.

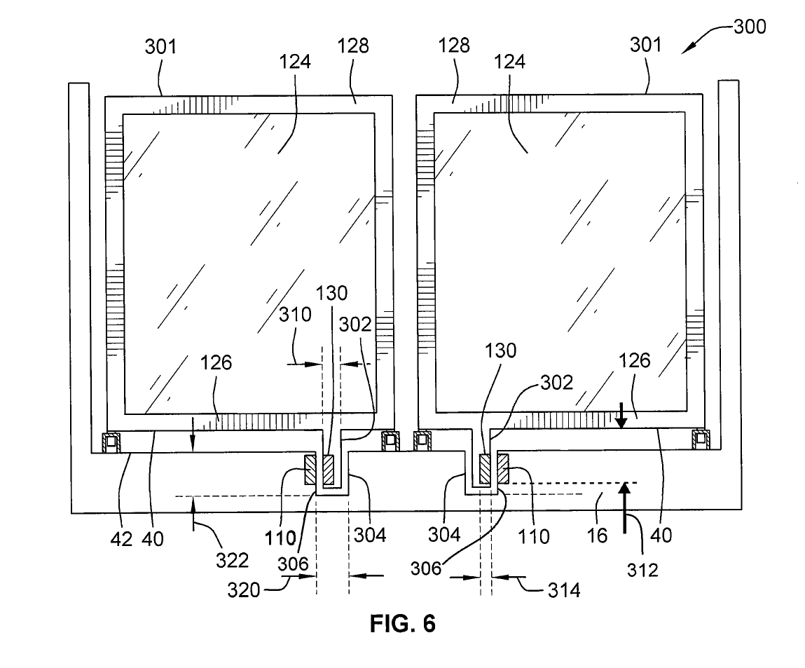

FIG. 6 is a top view of another exemplary inductive lighting assembly 300 that may be installed on the appliance 10 shown in FIGS. 1-2. The inductive lighting assembly 300 is substantially similar to the inductive lighting assemblies 100 and 250 shown in FIGS. 3-5. Specifically, the inductive lighting assembly 300 includes at least one shelf 301 that may be installed in the appliance 10 shown in FIG. 1. In the exemplary embodiment, the inductive lighting assembly 300 includes a plurality of shelves 301. As shown in FIG. 6, the inductive lighting assembly 300 includes a projection 302 that extends outwardly from the rearward edge 40 of the shelf 301. The projection 302 is formed from a plastic material that facilitates shielding the secondary coil 130 housed therein. The projection 302 may be formed separately from, and then attached to, the shelf border 126. Optionally, the projection 302 may be formed unitarily with the shelf border 126. The secondary coil 130 is disposed within the projection 302 such that the secondary coil 130 is substantially perpendicular to the rearward edge 40 of the shelf 301 and also substantially parallel with the primary coil 110.

The inductive lighting assembly 300 also includes a coil locator channel 304 that is configured to receive at least a portion of the projection 302, and thus the secondary coil 130, therein. In one embodiment, the coil locator channel 304 is formed into the rearward side 42 of the liner 16. More specifically, the liner 16 is molded to form the coil locator channel 304 therein. In the exemplary embodiment, the primary coil 110 is installed proximate to the coil locator channel 304 behind the liner 16. Specifically, the primary coil 110 is installed behind the liner 16 substantially parallel to a side 306 of the coil locator channel 304 such that the primary coil 110 is substantially perpendicular with the rearward side 42 of the liner 16 and also substantially parallel to the secondary coil 130.

As shown in FIG. 6, the projection 302 has a width 310 and a length 312. The width 310 is selected based on a thickness 314 of the secondary coil 130 housed therein. Moreover, the length 312 is selected based on a predetermined parasitic resistance desired to be incorporated into the shelf 301. For example, increasing the projection length 312 increases a distance between the shelf 301 and the primary coil 110 and thus increases a distance between metallic objects that may be stored on the shelf 301 and the primary coil 110. The increased distance thus reduces the probability that the metallic objects divert power from the primary coil 110 causing the light assembly 132 to dim, flicker, or turn off. Whereas, decreasing the projection length 312 positions the metallic objects closer to the primary coil 110. In the exemplary embodiment, the projection length 312 is sized such that any metallic objects placed on the shelf 301 are sufficiently displaced from the primary coil 110 such that the metallic objects have no effect on the transfer of power from the primary coil 110 to the secondary coil 130.

As shown in FIG. 6, the coil locator channel 304 also has a width 320 and a depth 322. The width 320 is selected based on the width 310 of the projection 302. In the exemplary embodiment, the width 320 is slightly greater than the width 310 of the projection 302 to enable the projection 302 to be inserted therein. Moreover, the width 320 is sized to limit movement between the projection 302 and the coil locator channel 304 and function to guide the operator when installing the shelf 301 into the appliance 10. The width 310 of the projection 302 and the width 320 of the coil locator channel 304 are sized such that when the projection 302 is installed in the coil locator channel 304, the primary coil 110 and the secondary coil 130 are within approximately 5 millimeters along a vertical axis extending through each coil.

The depth 322 of the coil locator channel 304 is selected based on a predetermined parasitic resistance desired to be incorporated into the shelf 301 as discussed above. It should be realized that the depth 322 of the coil locator channel 304 and the length 312 of the projection 302 are each selected to facilitate ensuring that any metallic objects placed on the shelf 301 are sufficiently displaced from the primary coil 110 such that the metallic objects have no effect on the transfer of power from the primary coil 110 to the secondary coil 130. Moreover, the depth 322 of the coil locator channel 304 and the length 312 of the projection 302 are each selected such that the primary coil 110 is in close proximity to the secondary coil 130 to promote inductive power transfer. In the exemplary embodiment, the width 320 of the coil locator channel 304 and the width 310 of the projection 302 are each selected such that the primary coil 110 is separated from the secondary coil 130 by a distance of approximately 5 millimeters. However, it should be realized that the distance separating the primary coil 110 and the secondary coil 130 may be either increased or decreased depending upon the coils utilized and the required inductive power to be transferred to the light assembly 132.

As shown in FIG. 6, the projection 302 may be formed as an integral part of the shelf 301. Optionally, the secondary coil 130 may be housed in a discreet enclosure (not shown) that is mounted to the shelf frame 128. The projection 302 and channel 304 may be located anywhere along the back edge 40 of the shelf 301 and the cabinet 12. For example, the projection 302 and the channel 304 may be located in the exact center of the width of the shelf 301 such that the shelves 301 are interchangeable from the right column to the left column as shown in FIG. 2. In this embodiment, the width 310 of the projection 302 and the width of the coil locator channel 304 are both less than the widths of the projection 202 and coil locator channel 204 described above. The reduced widths and the increased lengths of both the projection 302 and the coil locator channel 304 facilitate reducing the interaction between the parasitic metal and the primary coil 110.

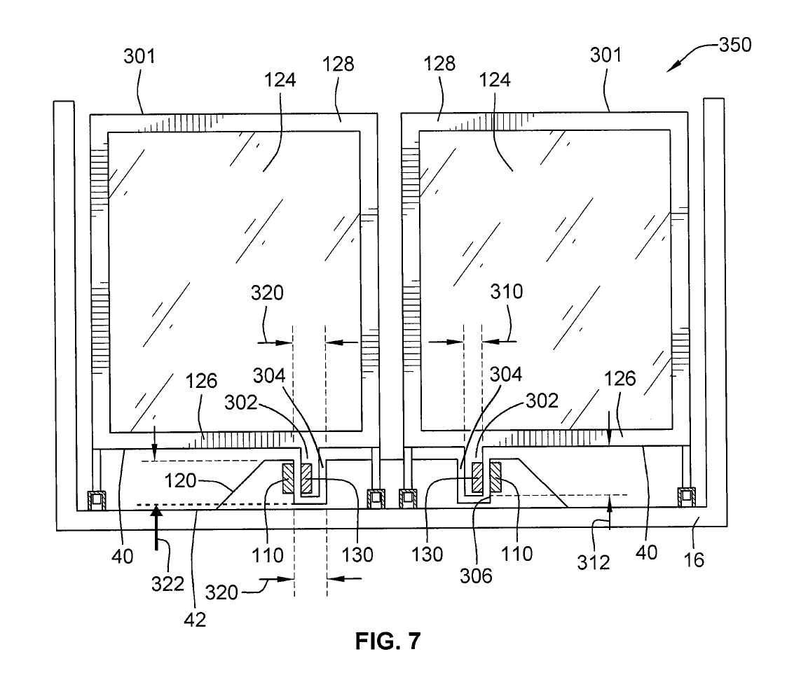

FIG. 7 is a top view of a portion of another exemplary inductive lighting assembly 350 that may be installed on the appliance shown in FIG. 1. The inductive lighting assembly 350 is substantially similar to the inductive lighting assembly 300 described above. The inductive lighting assembly 350 includes the plurality of shelves 301 wherein each shelf 301 includes the projection 302 described above. In this embodiment, the inductive lighting assembly 350 includes the shroud 120. As shown in FIG. 7, in this exemplary embodiment, the shroud 120 is molded to form the coil locator channel 304 therein. The shroud 120 may be formed as a large injection molded component that is utilized to cover the primary coil 110 and also cover water lines, air ducts, etc. In the exemplary embodiment, the primary coil 110 is installed proximate to the coil locator channel 304 behind the shroud 120. Specifically, the primary coil 110 is installed behind the shroud 120 substantially parallel to a side 306 of the coil locator channel 304 such that the primary coil 110 is substantially perpendicular with the rearward side 42 of the liner 16 and also substantially parallel to the secondary coil 130.

The depth 322 of the coil locator channel 304 is selected based on a predetermined parasitic resistance desired to be incorporated into the shelf 301 as discussed above. It should be realized that the depth 322 of the coil locator channel 304 and the length 312 of the projection 302 are each selected to facilitate ensuring that any metallic objects placed on the shelf 301 are sufficiently displaced from the primary coil 110 such that the metallic objects have no effect on the transfer of power from the primary coil 110 to the secondary coil 130. Moreover, the depth 322 of the coil locator channel 304 and the length 312 of the projection 302 are each selected such that the primary coil 110 is in close proximity to the secondary coil 130 to promote inductive power transfer. In the exemplary embodiment, the width 320 of the coil locator channel 304 and the width 310 of the projection 302 are each selected such that the primary coil 110 is separated from the secondary coil 130 by a distance of approximately 5 millimeters. However, it should be realized that the distance separating the primary coil 110 and the secondary coil 130 may be either increased or decreased depending upon the coils utilized and the required inductive power to be transferred to the light assembly 132.

As shown in FIG. 7, the projection 302 may be formed as an integral part of the shelf 301. Optionally, the secondary coil 130 may be housed in a discreet enclosure (not shown) that is mounted to the shelf frame 128. The projection 302 and channel 304 may be located anywhere along the back edge 40 of the shelf 301 and the cabinet 12. For example, the projection 302 and the channel 304 may be located in the exact center of the width of the shelf 301 such that the shelves 301 are interchangeable from the right column to the left column as shown in FIG. 2. In this embodiment, the width 310 of the projection 302 and the width of the coil locator channel 304 are both less than the widths of the projection 202 and coil locator channel 204 described above. The reduced width and increased lengths of both the projection 302 and the coil locator channel 304 facilitate reducing the interaction between the parasitic metal and the primary coil 110.

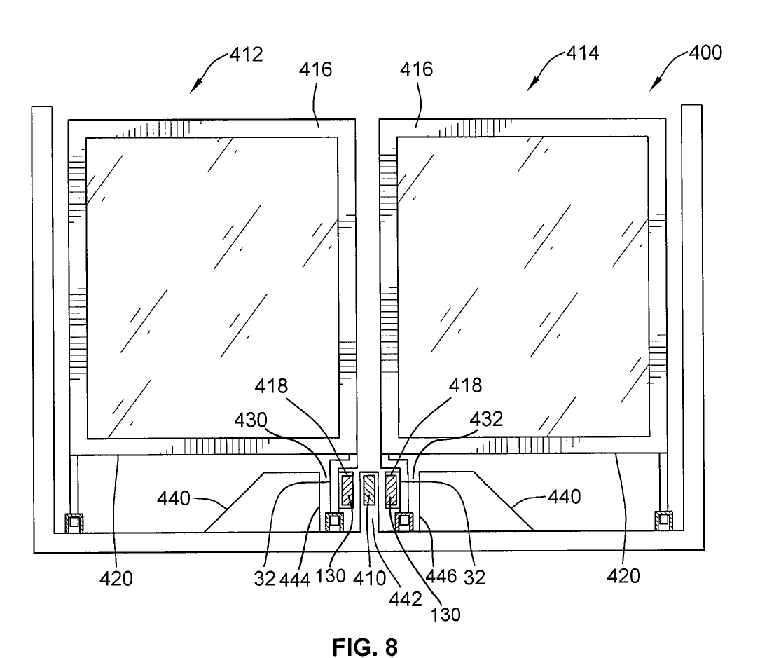

FIG. 8 is a top view of another exemplary inductive lighting assembly 400 that may be installed on the appliance shown in FIG. 1. The inductive lighting assembly 400 includes a single primary coil 410 that is configured to supply power to two columns 412 and 414 of shelves. Accordingly, each column 412 and 414 includes a plurality of shelves 416 that are arranged in the columns as shown in FIG. 8. Each shelf 416 includes a single projection 418 that extends outwardly from a rearward edge 420 of the each shelf 416. In the exemplary embodiment, the projection 418 is formed from a plastic material that facilitates shielding the secondary coil 130 housed therein. The projection 418 may be formed separately from, and the attached to the shelf 416. Optionally, the projection 418 may be formed unitarily with the shelf 416. The secondary coil 130 is disposed within the projection 418 such that the secondary coil 130 is substantially perpendicular to the rearward edge 420 of the shelf 416 and also substantially parallel with the primary coil 410.

The inductive lighting assembly 400 also includes a coil locator channel 430 that is configured to receive at least a portion of a projection 418, and thus the secondary coil 130, therein. Additionally, the inductive lighting assembly 400 also includes a second coil locator channel 432 that is configured to receive at least a portion of another projection 418, and thus another secondary coil 130, therein. In one embodiment, the coil locator channels 430 and 432 are formed into the rearward side 42 of the liner 16 (shown in FIG. 2). In the exemplary embodiment, shown in FIG. 8, to the coil locator channels 430 and 432 are formed in a shroud 440. In the exemplary embodiment, the primary coil 410 is installed between the coil locator channels 430 and 432 behind the shroud 440. Specifically, the shroud 440 is molded to form a pocket 442 that houses the primary coil 410. The pocket 442 maintains the primary coil 110 substantially parallel to a side 444 of the coil locator channel 430 and to another side 446 of the coil locator channel 432 such that the primary coil 410 is substantially parallel to both secondary coils 130. Similar to FIG. 6, the projections 418 each have a length and a width that is predetermined as discussed above with respect to the inductive lighting assembly 300. The inductive lighting assembly 400 shown in FIG. 8 includes only a single primary coil 410 that is utilized to provide power to at least two secondary coils 130, thus reducing the overall cost of the inductive lighting assembly 400.

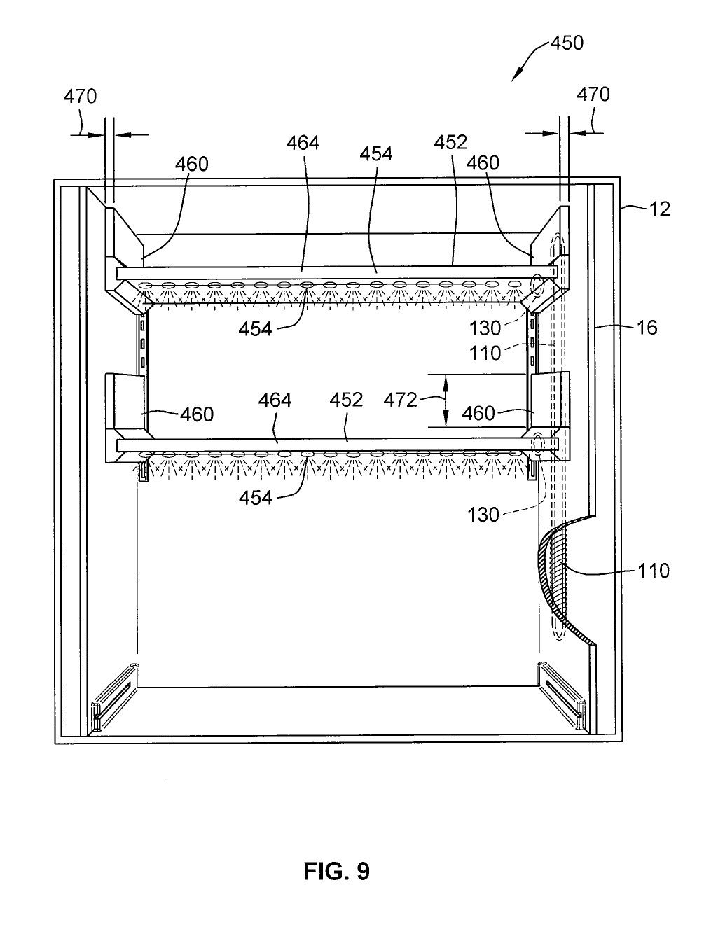

FIG. 9 is a side cross-sectional view of another exemplary inductive lighting assembly 450 that may be installed on the appliance 10 shown in FIG. 1. The inductive lighting assembly 450 includes at least one primary coil 110 that is configured to supply power to a plurality of shelves 452. The primary coil 110 may be located on the back wall of the liner 16 as shown in FIG. 2. Optionally, the primary coil 110 may be installed on the side wall of the appliance 10 as shown in FIG. 9.

In this embodiment, each shelf 452 is configured to be mounted directly against or flush with the side of the liner 16 such that the secondary coil 130 is mounted in close proximity to the primary coil 110. The secondary coil 130 and the primary coil 110 are in close proximity in order to help facilitate the inductive power transfer as described below.

In operation, a light assembly 454 receives power through inductive coupling or inductive power transfer from the primary coil 110. As a result of inductive power transfer, power may be wirelessly transferred from the primary coil 110 to the light assembly 454 via the secondary coil 130. The transfer of power takes place by electromagnetic coupling through a process known as mutual induction. The primary coil 110 is positioned proximate to the secondary coil 130 in order to successfully transfer power inductively. Specifically, the power is inductively transferred from the primary coil 110 to the secondary coil 130. The secondary coil 130 then transfers power to the light assembly 452 which in turn then powers and illuminates the LEDs (not shown) in order to illuminate the interior of the appliance 10.

In the exemplary embodiment, the shelf 452 includes a piece of glass (not shown) that is encapsulated within a plastic injection molded border 464. The shelf 452 is mounted onto a metal frame (not shown). The frame interlocks, via the shelf supports, into the pair of frame supports (not shown) to enable an operator to attach the shelf 452 to the appliance 10 as described above with respect to shelf 30. During installation, the shelf 452 is mounted very close to the liner 16.

During operation, the secondary coils 130 electromagnetically couples with the primary coil 110. An electrical current induced into the secondary coils 130 is used to power the light assembly 454 mounted on the shelves 452. However, undesirable situations may occur when metal objects that are placed on the shelves 452 come too close to the primary coil 110. Accordingly, the shelves 452 illustrated in FIG. 9 each include a shelf extension 460 that facilitates preventing parasitic interference that may occur when a metallic container, for example, an aluminum container, is inadvertently placed in contact with the wall of the appliance proximate to the primary coil 110.

The shelf extension 460 may be fabricated unitarily with the border 464. Optionally, the shelf extension 460 may be fabricated as a separate component that is coupled to the border 464. The shelf extension 460 has a width 470 and a length 472. The width 470 and the length 472 are each selected based on a predetermined parasitic resistance desired to be incorporated into the shelf 452. In the exemplary embodiment, the width 470 and the length 472 of the shelf extension 460 are each selected to facilitate ensuring that any metallic objects placed on the shelf 452 are sufficiently displaced from the primary coil 110 such that the metallic objects placed on the shelf 452 have no effect on the transfer of power from the primary coil 110 to the secondary coil 130. Moreover, the width 470 of the shelf extension 460 is selected such that the primary coil 110 is in close proximity to the secondary coil 130 to promote inductive power transfer. In the exemplary embodiment, the width 470 of the shelf extension 460 is selected such that the primary coil 110 is separated from the secondary coil 130 by a distance of approximately 5 millimeters. However, it should be realized that the distance separating the primary coil 110 and the secondary coil 130 may be either increased or decreased depending upon the coils utilized and the required inductive power to be transferred to the light assembly 454. Specifically, the vertical shelf extensions 460 substantially prevent any parasitic metal objects from overhanging the shelf 452 and thus causing a parasitic interference between the primary coil 110 and the secondary coil 130.

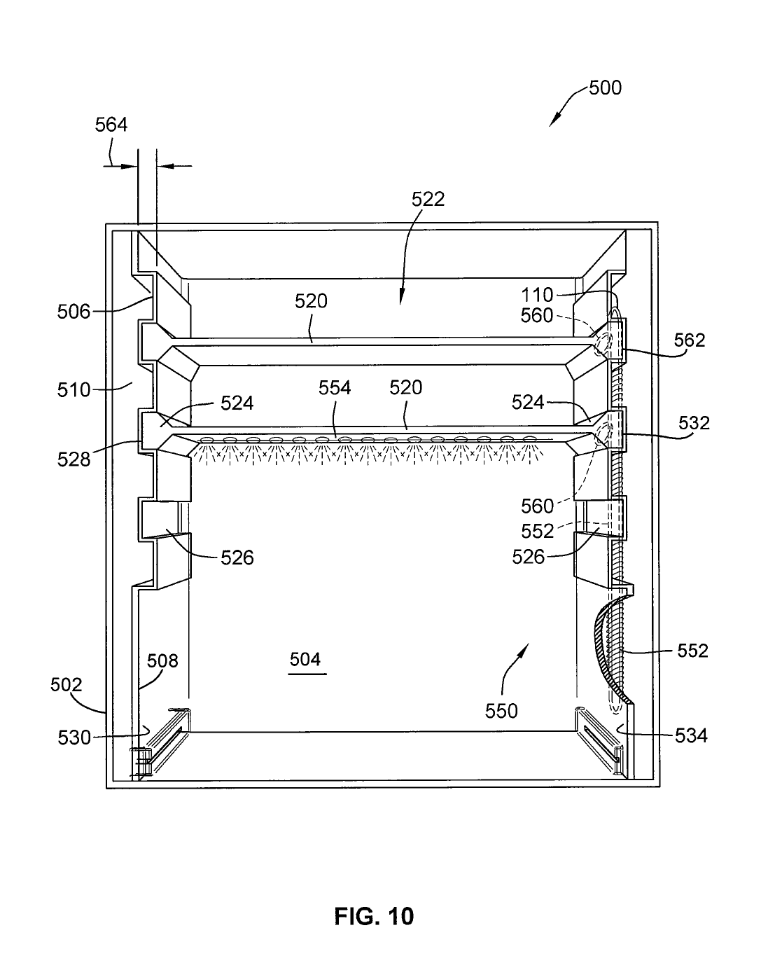

FIG. 10 is a front view of another exemplary appliance 500 that be configured to include an inductive lighting assembly that is discussed in more detail below. In the exemplary embodiment, the appliance 500 is a refrigerator/freezer appliance that includes a cabinet 502 that defines an interior space 504. The interior space 504 is defined by a liner 506 that is installed within the cabinet 502. The liner 506 may separate the interior space 504 of the appliance cabinet 502 from an insulation material (not shown) that is installed between the cabinet 502 and the liner 506. The liner 506 may include an interior side 508 and an exterior side 510. The interior side 508 forms the interior wall of the interior space 504 and the exterior side 510 faces the insulation material.

The appliance 500 also includes at least one shelf 520. In the exemplary embodiment, the appliance 500 includes a plurality of shelves 520 that are arranged in a single column 522. Each shelf includes two shelf brackets 524 that are each configured to be inserted into a respective recess 526 formed in the liner 506. In the exemplary embodiment, the liner 506 is fabricated to include a plurality of recesses 526, also referred to herein as molded in shelf supports. As shown in FIG. 10 a first recess 528 is molded in a first side 530 of the liner 506 and a second recess 532 is molded in an opposite second side 534 of the liner 506. The shelf 520 is then inserted into the appliance 500 by sliding the shelf 520 into the recesses 528 and 532. It should be realized that the appliance 500 may include a plurality of recesses configured to receive a plurality of shelves 520.

The appliance also includes an inductive lighting assembly 550. The inductive lighting assembly 550 includes at least one primary coil 552. In the exemplary embodiment, the primary coil 552 is installed on the proximate to the second side 534 of the liner 506 as shown in FIG. 10. Optionally, the primary coil 552 may be installed proximate to the first side 530 of the liner 506. The primary coil 552 is configured to supply power to a lighting assembly 554 that is installed on each respective shelf 520.

The inductive lighting assembly 550 also includes a secondary coil 560 that is coupled to each respective shelf 520. In this embodiment, each secondary coil 560 is coupled to a side 562 of a respective shelf 520 proximate to a respective recess 526. Accordingly, when the shelf 520 is mounted within the appliance 500, by inserting the shelf 520 into the recess 526, the secondary coil 560 is mounted in close proximity to the primary coil 552. The secondary coil 560 and the primary coil 552 are in close proximity in order to help facilitate the inductive power transfer as described above.

In operation, because the shelves 520 are inserted into the recesses 526, the secondary coil 560 is separated from the primary coil 552 by a predetermined distance. The predetermined distance may be adjusted by either increasing or decreasing a depth 564 of the recess 526. The depth 564 of the recess 526 is selected such that when metal objects are placed on the shelves 520, the metal objects are separated from the primary coil 552 by the predetermined distance to facilitate preventing parasitic interference that may occur when a metallic container, for example, an aluminum container, is inadvertently placed in contact with the wall or in close proximity to the primary coil 552.

Described herein are various embodiments of inductively powered lighting assemblies that enable a parasitic metal object to be placed on the shelf without diverting power from the primary coil. The exemplary embodiments described herein also facilitate proper positioning of the primary coil and the secondary coil and minimize or eliminate the unwanted effects of parasitic metal.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

What is claimed is:

1. An inductive lighting assembly for an appliance, the appliance including a cabinet, a liner installed in the cabinet, and at least one shelf mounted in the cabinet, said inductive lighting assembly comprising:
a coil locator channel recessed into the cabinet;
a primary coil mounted proximate to the coil locator channel;
a shelf having a projection coupled thereto; the projection configured to be at least partially inserted into the coil locator channel to separate a metallic object placed on the shelf from the primary coil by a predetermined distance; and
a secondary coil mounted in the projection, the primary coil transferring power to the secondary coil through inductive power transfer, the secondary coil being electrically connected to a light assembly installed in the appliance.

2. An inductive lighting assembly in accordance with claim 1, wherein the predetermined distance is sufficient to substantially eliminate parasitic inductance between the metallic object and the primary coil.

3. An inductive lighting assembly in accordance with claim 1, wherein the projection is formed unitarily within the shelf and the secondary coil is located within the projection.

4. An inductive lighting assembly in accordance with claim 1, wherein the coil locator channel is recessed into the liner.

5. An inductive lighting assembly in accordance with claim 1, wherein the cabinet further comprises a shroud covering the primary coil, the coil locator channel being formed in the shroud.

6. An inductive lighting assembly in accordance with claim 1 wherein the appliance comprises a plurality of shelves each shelf including a projection having a secondary coil mounted therein, the primary coil being mounted in a vertical orientation to enable power to be transferred from the primary coil to the plurality of secondary coils through inductive power transfer, each secondary coil being electrically connected to a light assembly installed in the appliance.

7. An inductive lighting assembly in accordance with claim 1 wherein the secondary coil is located substantially parallel to a rearward edge of the shelf and substantially parallel with the primary coil.

8. An inductive lighting assembly in accordance with claim 1 wherein the appliance includes at least two columns of shelves, each shelf including a projection having a secondary coil mounted therein, the primary coil being mounted in a vertical orientation between the two columns of shelves to enable power to be transferred from the primary coil to the plurality of secondary coils through inductive power transfer.

9. An inductive lighting assembly in accordance with claim 1 wherein at least one of the shelves includes a shelf border and a shelf extension coupled to the shelf border, the shelf extension configured to maintain a predetermined distance between a metallic object placed on the shelf and the primary coil.

10. An inductive lighting assembly in accordance with claim 1 wherein the appliance includes two columns of shelves, each shelf including a projection having a secondary coil mounted therein, the primary coil being mounted in a vertical orientation between the two columns of shelves to enable power to be transferred from the primary coil to the two columns of shelves through inductive power transfer.

11. An inductive lighting assembly in accordance with claim 1 wherein the appliance is a refrigerator.

12. An inductive lighting assembly in accordance with claim 1 wherein at least one shelf comprises:
a molded shelf border; and
a shelf extension coupled to the molded shelf border, the shelf extension configured to separate a metallic object placed on the shelf from the primary coil by a predetermined distance.

13. An appliance comprising:
a liner having a plurality of recesses formed therein;
a primary coil installed proximate to at least one of the recesses; and
at least one shelf configured to be inserted into the recess, the shelf including a secondary coil, the primary coil transferring power to the secondary coil through inductive power transfer, the secondary coil being electrically connected to a light assembly installed on the shelf.

14. An appliance in accordance with claim 13 wherein the appliance comprises a refrigerator.

15. An appliance in accordance with claim 13 wherein the appliance further comprises a single column of shelves, each shelf including a secondary coil, the primary coil being mounted in a vertical orientation to enable power to be transferred from the primary coil to the plurality of secondary coils through inductive power transfer, each secondary coil being electrically connected to a light assembly installed in the appliance.

16. A refrigerator comprising:
a cabinet;
a liner installed in the cabinet;
a plurality of shelves installed in the cabinet, at least one of the shelves having a projection coupled thereto; and
an inductive lighting assembly, the inductive lighting assembly including a coil locator channel recessed into at least one of the liner or the cabinet, a primary coil mounted proximate to the coil locator channel, and a secondary coil mounted in the shelf projection, the shelf projection configured to be at least partially inserted into the coil locator channel to separate a metallic object placed on the shelf from the primary coil by a predetermined distance, the primary coil transferring power to the secondary coil through inductive power transfer, the secondary coil being electrically connected to a light assembly installed on the shelf.

17. The refrigerator in accordance with claim 16 wherein the predetermined distance is sufficient to substantially eliminate parasitic inductance between the metallic object and the primary coil.

18. The refrigerator in accordance with claim 16 wherein the projection is formed unitarily within the shelf and the secondary coil is located within the projection.

19. The refrigerator in accordance with claim 16 wherein the cabinet further comprises a shroud covering the primary coil, the coil locator channel being formed in the shroud.

20. The refrigerator in accordance with claim 16 wherein the refrigerator includes two columns of shelves, each shelf including a projection having a secondary coil mounted therein, the primary coil being mounted in a vertical orientation between the two columns of shelves to enable power to be transferred from the primary coil to the two columns of shelves through inductive power transfer.
